(19) United States
(12) Patent Application Publication
(10) Pub. No.: US 2006/0152201 A1
(43) Pub. Date: Jul. 13, 2006

(54) Electrical circuit for voltage transformation and use of said electrical circuit

(75) Inventors: Dietmar Czekay, Dresden (DE); Martin Honsberg-Riedl, Teisendorf (DE)

Correspondence Address: OSRAM SYLVANIA INC, 100 ENDICOTT STREET, DANVERS, MA, 01923, US

(73) Assignee: PATENT-TREUHAND-GESELLSCHAFT FOR ELEKTRISCHE GLUHLAMPEN MBH, Munchen (DE)

(21) Appl. No.: 10/527,995

(22) PCT Filed: Aug. 20, 2003
(86) PCT No.: PCT/DE03/02774

§ 371 Date: Mar. 21, 2005

(30) Foreign Application Priority Data
Sep. 20, 2002 (DE) 102 43 860.9

(51) Int. Cl. G05F 1/656; G05F 1/10

(52) U.S. Cl. 323/222

(57) ABSTRACT

An electrical circuit for voltage transformation, the electrical circuit being suitable for power factor correction, enables a good power factor correction to be achieved with a high efficiency of between 80% and 95% in the MHz frequency region. To this end, few components suitable for high frequencies (capacitors, inductances, diodes and high frequency switches) are used. The diodes are, for example, Schottky diodes with SiC as the diode material. The high frequency switch includes a powerful MOS transistor.

The invention relates to an electrical circuit for voltage transformation and a use of the electrical circuit.

A multiplicity of electrical apparatuses are operated with DC current or DC voltage. For operation of such an apparatus, a DC voltage is formed from an AC voltage of a power supply system. This is done for example with the aid of an electrical input circuit with rectifier diode and buffer capacitor. What is disadvantageous about this is that current can flow from the power supply system into the buffer capacitor only when the voltage across the buffer capacitor is less than the power supply system voltage. The result is a high non-sinusoidal pulsed current with a correspondingly high loading on the power supply system with harmonics. As a consequence of this, the input circuit is distinguished by a low power factor. The power factor is dependent on the phase shift between current and voltage at the connecting point of an electrical apparatus fed via the input circuit. Besides a low active power, a low power factor means a relatively high loss of reactive and harmonic power.

A so-called power factor correction (PFC) is carried out in order to reduce the harmonics and thus in order to increase the power factor. The power factor correction has the effect that the profiles of voltage and current are in phase. The relative current amplitude follows the relative voltage amplitude. As a consequence of this, the input circuit behaves virtually as a nonreactive resistance with respect to the power supply system.

A present-day power factor correction circuit that is realized for example in a so-called electronic ballast is operated at a switching frequency from the range of 20 kHz to 100 kHz. A high efficiency and a good power factor correction are possible at these switching frequencies. At a specific power, however, the structural size of the electronic ballast can be reduced only to a limited extent on account of the requisite inductances and capacitances. A significant reduction of the structural size of the electronic ballast or the power factor correction circuit could be achieved for example by increasing the switching frequency. However, the efficiency of the power factor correction circuit decreases at a switching frequency from the MHz range.

It is an object of the present invention to specify an electrical circuit which can be used as a power factor correction circuit, the intention being to enable a good power factor correction in conjunction with high efficiency even at a switching frequency from the MHz range.

A first solution that achieves the object specifies an electrical circuit for voltage transformation, having at least one input terminal for feeding in an electrical input power by applying a positive electrical DC voltage that changes temporally with respect to an electrical reference potential, at least one reference potential terminal for applying the reference potential, at least one output terminal for drawing an electrical output power, at least one input diode having an anode and a cathode, at least one output diode having an anode and a cathode, at least one input capacitance having an electrode and a counterelectrode, at least one transfer capacitance having an electrode and a counterelectrode, at least one input inductance having an inductance terminal and a further inductance terminal, and at least one base point inductance having an inductance terminal and a further inductance terminal, in which case the anode of the input diode and the input terminal have a common node, the cathode of the input diode, the inductance terminal of the input inductance and the electrode of the input capacitance have a common node, the counterelectrode of the input capacitance, the reference potential terminal and the inductance terminal of the base point inductance have a common node, the further inductance terminal of the input inductance and the electrode of the transfer capacitance have a common node, the counterelectrode of the transfer capacitance and the further inductance terminal of the base point inductance have a common node, a radiofrequency switch for producing and/or interrupting an electrically conductive connection between the reference potential terminal and the common node of the further inductance terminal of the input inductance and the electrode of the transfer capacitance and a means for forwarding the electrical output power to the output terminal are present, the means having the base point inductance and the output diode and the cathode of the output diode having a common node with the output terminal.

A second solution that achieves the object specifies an electrical circuit for voltage transformation, having at least one input terminal for feeding in an electrical input power by applying a negative electrical DC voltage that changes temporally with respect to an electrical reference potential, at least one reference potential terminal for applying the reference potential, at least one output terminal for drawing an electrical output power, at least one input diode having an anode and a cathode, at least one output diode having an anode and a cathode, at least one input capacitance having an electrode and a counterelectrode, at least one transfer capacitance having an electrode and a counterelectrode, at least one input inductance having an inductance terminal and a further inductance terminal, and at least one base point inductance having an inductance terminal and a further inductance terminal, in which case the cathode of the input diode and the input terminal have a common node, the anode of the input diode, the inductance terminal of the input inductance and the electrode of the input capacitance have a common node, the counterelectrode of the input capacitance, the reference potential terminal and the inductance terminal of the base point inductance have a common node, the further inductance terminal of the input inductance and the electrode of the transfer capacitance have a common node, the counterelectrode of the transfer capacitance and the further inductance terminal of the base point inductance have a common node, a radiofrequency switch for producing and/or interrupting an electrically conductive connection between the reference potential terminal and the common node of the further inductance terminal of the input inductance and the electrode of the transfer capacitance and a means for forwarding the electrical output power to the output terminal are present, the means having the base point inductance and the output diode and the anode of the output diode having a common node with the output terminal.

In accordance with a further aspect of the invention, the electrical circuits described are used for power factor correction, an electrical input power that is fed in being subjected to power factor correction. The power drawn from the power supply system is corrected in terms of the power factor.

The two solutions that achieve the object differ in that the electrical input power can be fed in by applying a DC voltage that is positive with respect to the reference potential in accordance with the first solution and by applying a DC voltage that is negative with respect to the reference potential in accordance with the second solution. Accordingly, the contact-connections of the input diode and the output diode of the two solutions are opposite to one another. The reference potential terminal is grounded, for example, so that the reference potential is the ground potential.

The applied DC voltage is principally a DC voltage pulsating with a relatively low frequency. By way of example, the DC voltage is obtained from a customary, sinusoidal AC voltage of a public electricity supply system with the aid of a rectifier circuit. Consequently, by way of example, a DC voltage of 230 V pulsating with a frequency of 100 Hz is present at the input terminal. It is also conceivable for the input power to be fed in with the aid of a severely disturbed power supply system voltage with superposed current pulses.

The input power is subjected to power factor correction by means of the electrical circuits. The output power is coupled out from the electrical circuit in accordance with the switching frequency of the radiofrequency switch. A switching frequency of the radiofrequency switch is selected from the MHz frequency range. An output power is drawn from the electrical circuit which has a DC voltage pulsating with the switching frequency of the radiofrequency switch. In this case, it has been shown that, on the basis of the circuits described in conjunction with good power factor correction, a high efficiency of 80% to 95% can be achieved even at a switching frequency from the MHz frequency range. This is possible in particular when components suitable for radiofrequency (switching transistors, capacitances, inductances and diodes) are used for the electrical circuits.

In a particular refinement, the means for forwarding the electrical output power to the output terminal has the common node of the counterelectrode of the transfer capacitance and the further inductance terminal of the base point inductance. In accordance with a development of the first solution, said node and the anode of the output diode are electrically conductively connected. In accordance with a development of the second solution, said node and the cathode of the output diode are electrically conductively connected.

By way of example, a radiofrequency switch with a switching transistor is used. The radiofrequency switch is embodied by a switching transistor. Given suitable tuning of the reactive components, the switching frequency and a switch-on duration of the radiofrequency switch, it is possible to achieve a significant relieving of the switching loading on the switching transistor. A switch-on voltage of the switching transistor can be reduced by up to 80% in this case, as a result of which it is possible virtually to realize a so-called zero voltage switching (ZVS). Given a low reverse voltage loading on the switching transistor, a low switching loss of the radiofrequency switch occurs, which contributes to the high efficiency of the circuit.

In a particular refinement, the means for forwarding the electrical output power comprises at least one further reference potential terminal for applying a further reference potential and at least one transformer, having at least one primary inductance having an inductance terminal and a further inductance terminal and at least one secondary inductance having an inductance terminal and a further inductance terminal, in which case the primary inductance has the base point inductance and the inductance terminal of the secondary inductance and the further reference potential terminal have a common node. In accordance with a development of the first solution, the further inductance terminal and the anode of the output diode have a common node. In accordance with a development of the second solution, the further inductance terminal and the cathode of the output diode have a common node.

The reference potential terminal and the further reference potential terminal may have a common node. The reference potential and the further reference potential may thus be identical. However, the reference potential terminals may also not have a common node. Reference potential and further reference potential may thus also differ from one another.

In comparison with the previous examples, a transformer is used instead of the base point inductance. The primary inductance of the transformer performs the function of the base point inductance of the electrical circuit. Primary inductance and secondary inductance are coupled to one another. A reverse voltage loading on the switching transistor when using a transformer is significantly higher, with a factor of 1.3 to 2.0, in comparison with the reverse voltage loading on the switching transistor when using the base point inductance in accordance with embodiments described previously. In return, a standard-conforming DC isolation between input terminal and output terminal can be realized with the aid of the transformer.

In a particular refinement, the means for forwarding the electrical output power has at least one output capacitance having an electrode and a counterelectrode, the counterelectrode of the output capacitance and the common node of the further reference potential terminal and the inductance terminal of the secondary inductance being electrically conductively connected. In a development of the first solution, the electrode of the output capacitance and the common node of the further inductance terminal of the secondary inductance and the anode of the output diode are electrically conductively connected. By contrast, in a development of the second solution, the electrode of the output capacitance and the common node of the further inductance terminal of the secondary inductance and the cathode of the output diode are electrically conductively connected.

In a particular refinement, the transformer is a radiofrequency/high-voltage (RF/HV) transformer. Such a transformer has been proposed for example in German patent application 10232952.4. Despite a small structural size, the transformer can be operated at a frequency of up to 200 MHz and a voltage of up to 2000 V. The transformer is distinguished by a high power throughput, a high quality factor and thus low losses.

In a further refinement, for the purpose of relieving the switching load on the radiofrequency switch, at least one tuning capacitance having an electrode and a counterelectrode is present, the electrode of the tuning capacitance and the common node of the further inductance terminal of the input inductance and the electrode of the transfer capacitance are electrically conductively connected and the counterelectrode of the tuning capacitance and the reference potential terminal are electrically conductively connected. With the aid of the tuning capacitance, the loading or relieving of the loading on the switching transistor of the radiofrequency switch can be manipulated relatively easily and the efficiency of the circuit can thus be optimized. As a result, by way of example, it is possible to achieve the zero voltage switching already mentioned above.

The radiofrequency switch has for example an IGBT or a radiofrequency bipolar transistor. In particular, the radiofrequency switch has at least one MOS transistor. The MOS transistor is configured as an n-channel MOSFET in accordance with the first solution and as a p-channel MOSFET in accordance with the second solution. The MOS transistor is, in particular, a CoolMOS® transistor. These transistors are suitable for radiofrequency applications. In particular, the radiofrequency switch has a switching frequency selected from the range of 500 kHz to 200 MHz inclusive. A good power factor correction can be achieved with a high efficiency even at these high switching frequencies. The switching frequency is for example approximately 2.7 MHz. The switch-on duration (duration of the contact produced between the further inductance terminal of the input inductance, the electrode of the transfer capacitance and the reference potential terminal) is for example approximately 80 ns.

The electrical circuits may be used for power control. This is effected in particular by pulse width modulation during which individual pulses are suppressed. As an alternative to this, the switch-on duration of the radiofrequency switch may also be varied for the purpose of power control.

In particular, besides the radiofrequency switch, the further components of the electrical circuit are suitable for radiofrequency. Thus, the input capacitance and/or the transfer capacitance have at least one radiofrequency capacitor having a capacitance selected from the range of 10 pF to 1000 pF inclusive. The tuning capacitance has at least one radiofrequency capacitor having a capacitance selected from the range of 10 pF to 200 pF inclusive. The output capacitance has at least one radiofrequency capacitor having a capacitance selected from the range of 300 pF to 3000 pF inclusive. The input inductance, the base point inductance, the primary inductance and/or the secondary inductance advantageously have an inductance selected from the range of 0.3 pH to 100 pH inclusive. In particular, the inductance is selected from the range of 4 pH to 40 pH. The input diode and/or the output diode is advantageously a Schottky diode. In particular, the Schottky diode has at least one diode material selected from the group SiC (silicon carbide) and/or GaAs (gallium arsenide).

To summarize, the invention affords the following essential advantages:
The electrical circuits comprise a relatively small number of components.
The construction of the electrical circuits can be miniaturized through the small number of components and through the use of inductances and capacitances suitable for radiofrequency.
The electrical circuits make it possible to achieve a very good power factor correction with a high efficiency of 80% to 95% in the MHz frequency range.
The circuits can be used for power control.

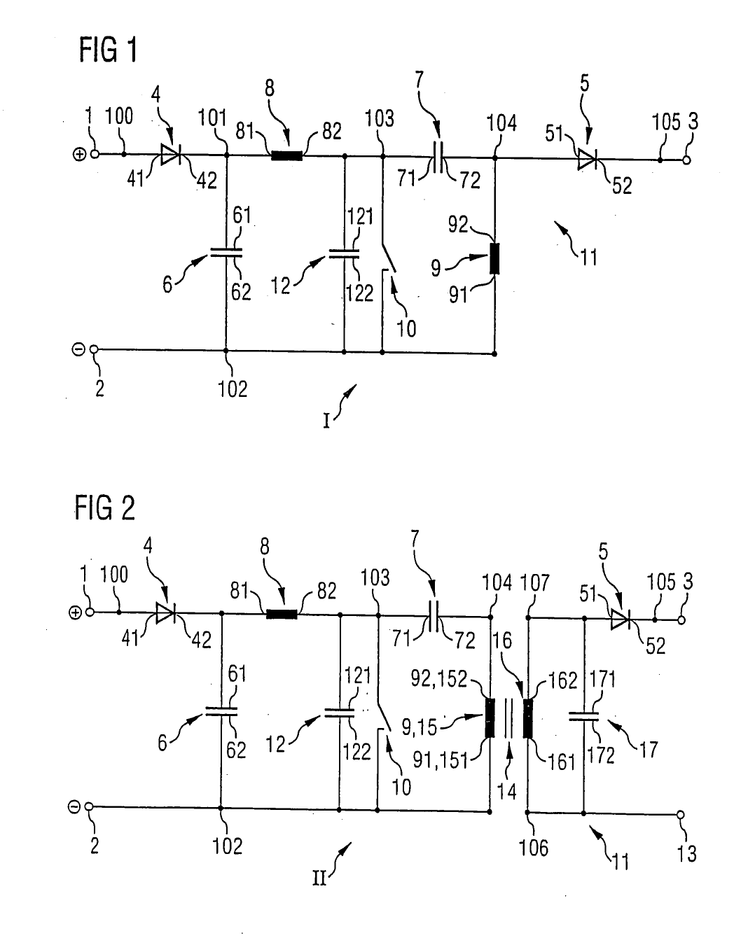

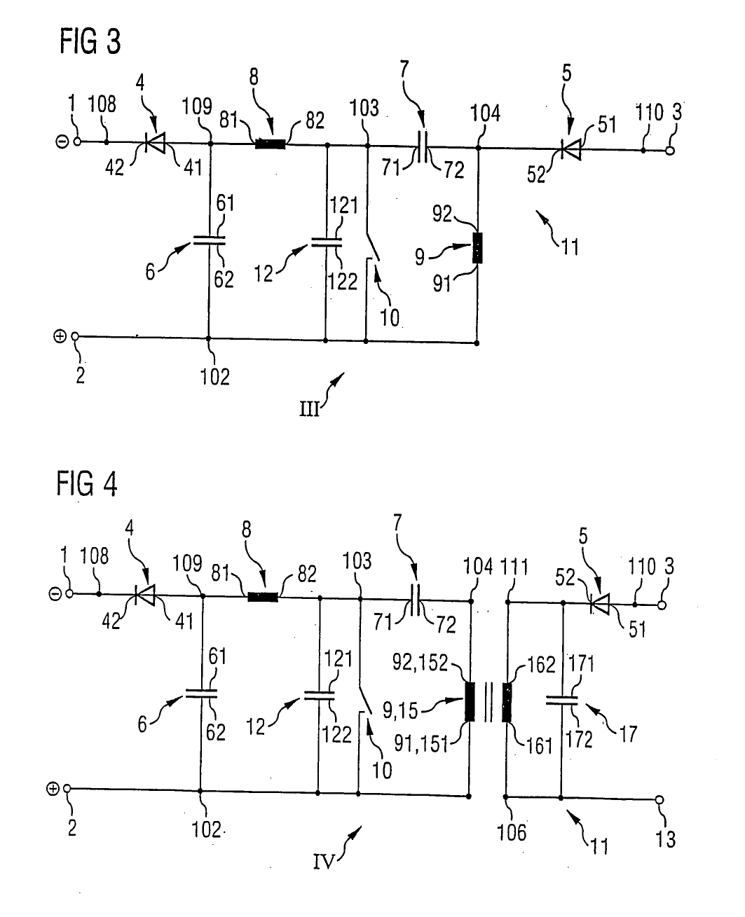

The invention is described in more detail below on the basis of a plurality of examples and the associated schematic figures. FIGS. 1 to 4 in each case show a circuit diagram of an electrical circuit for voltage transformation. The electrical circuits I (FIG. 1), II (FIG. 2), III (FIG. 3) and IV (FIG. 4) have an input terminal 1 for feeding in an electrical input power by applying an electrical DC voltage that changes temporally with respect to a reference potential, a reference potential terminal 2 for applying the reference potential, and an output terminal 3 for drawing an electrical output power. The electrical circuits have, as reactive components, an input diode 4, an output diode 5, an input capacitance 6, a transfer capacitance 7, an input inductance 8, a base point inductance 9 and a radiofrequency switch 10. In addition, a means 11 for forwarding the electrical output power to the output terminal 3 is present in each case, the output diode 3 and the base point inductance 9 being the essential parts of the means 11. In addition, the electrical circuits I to IV are in each case provided with a tuning capacitance 12 for manipulating the relieving of the loading on the radiofrequency switch 10. However, the tuning capacitance 12 is not absolutely necessary for the function of the circuits I-IV. Therefore, the tuning capacitance 12 is omitted in further exemplary embodiments (not illustrated).

The components are suitable for radiofrequency. Input diode 4 and output diode 5 are in each case Schottky diodes with SiC as diode material. As an alternative to this, the diode material of the Schottky diodes is GaAs. The input capacitance 6 has a radiofrequency capacitor having a capacitance of approximately 500 pF. The tuning capacitance 12 has a radiofrequency capacitor having a capacitance of approximately 100 pF and the transfer capacitance 7 has a radiofrequency capacitor having a capacitance of approximately 250 pF. The inductance of the input inductance 8 and base point inductance 9 is selected from the range of 4 μH to 40 μH. The radiofrequency switch 10 has a CoolMOS® transistor and can be operated with a switching frequency from the range of 500 kHz to 200 MHz.

The DC voltage to be applied to the input terminal 1 is a pulsating DC voltage of 230 V having a frequency of 100 Hz which is generated from a power supply system AC voltage by rectification in a rectifier circuit (not illustrated). The electrical output power can be drawn from the output terminal 3 by means of a load (not illustrated).

The elements of the circuits I to IV are arranged with respect to one another as follows:
In each case one of the electrodes (anode 41 or cathode 42) of the input diode 4 and the input terminal 1 are electrically conductively connected to one another and have the common node 100 or 108.
The respective counterelectrode (cathode 42 or anode 41) of the input diode 4, the inductance terminal 81 of the input inductance 8 and the electrode 61 of the input capacitance 6 are electrically conductively connected to one another and have the common node 101.
The counterelectrode 62 of the input capacitance 6, the reference potential terminal 2 and the inductance terminal 91 of the base point inductance 9 are electrically conductively connected to one another and have the common node 102.
The further inductance terminal 82 of the input inductance 8 and the electrode 71 of the transfer capacitance 7 are electrically conductively connected to one another and have the common node 103.
The counterelectrode 72 of the transfer capacitance 7 and the further inductance terminal 92 of the base point inductance 9 are electrically conductively connected to one another and have the common node 104.
The radiofrequency switch 10 is arranged in such a way that it is possible to produce and/or interrupt an electrically conductive connection between the reference potential terminal 2 and the common node 103 of the further inductance terminal 82 of the input inductance 8 and the electrode 71 of the transfer capacitance 7 with the switching frequency of the radiofrequency switch 10.
In each case one of the electrodes (anode 51 or cathode 52) of the output diode 5 and the output terminal 3 are electrically conductively connected to one another and have the common node 105 or 110.

### EXAMPLE 1

The circuit diagram of the associated electrical circuit I is illustrated in FIG. 1. A positive DC voltage is applied via the input terminal 1 (first solution to the underlying object). The anode 41 of the input diode 4 and the input terminal 1 have the common node 100. The cathode 42 of the input diode 4 has the common node 101 together with the inductance terminal 81 of the input inductance 8 and the electrode 61 of the input capacitance 6.

The means 11 for forwarding the electrical output power to the output terminal 3 has the common node 104 of the counterelectrode 72 of the transfer capacitance 7 and the further inductance terminal 92 of the base point inductance 9. Said node 104 and the anode 51 of the output diode 5 are electrically conductively connected to one another. The cathode 52 of the output diode 5 and the output terminal 3 are electrically conductively connected to one another and have the common node 105.

### EXAMPLE 2

The circuit diagram of the associated electrical circuit II is illustrated in FIG. 2. In contrast to the previous example 1, here the means 11 for forwarding the electrical output power to the output terminal 3 has a further reference potential terminal 13 for applying a further reference potential, a transformer 14 and an output capacitance 17. The transformer 14 is an RF/HV transformer and comprises the primary inductance 15 and the secondary inductance 16. Primary inductance 15 and secondary inductance 16 are coupled to one another. The primary inductance 15 is the base point inductance 9. Like the inductance of the primary inductance 15 (base point inductance 9), the inductance of the secondary inductance 16 is selected from the range of 4 μH to 40 μH. The output capacitance 17 has a radiofrequency capacitor having a capacitance of approximately 1500 pF.

Primary inductance 15, secondary inductance 16, further reference potential terminal 13 and output capacitance 17 are arranged as follows:
The inductance terminal 161 of the secondary inductance 16 and the further reference potential terminal 13 are electrically conductively connected to one another and have the common node 106.
The further inductance terminal 162 and the anode 51 of the output diode 5 are electrically conductively connected to one another and have the common node 107.
The counterelectrode 172 of the output capacitance 17 and the common node 106 of the further reference potential terminal 13 and the inductance terminal 161 of the secondary inductance 16 are electrically conductively connected to one another.
The electrode 171 of the output capacitance 17 and the common node 107 of the further inductance terminal 162 of the secondary inductance 16 and the anode 51 of the output diode 5 are electrically conductively connected to one another.

### EXAMPLE 3

The circuit diagram of the associated electrical circuit III is illustrated in FIG. 3. In contrast to example 1, a negative DC voltage is applied via the input terminal 1 (second solution to the underlying object). The cathode 42 of the input diode 4 and the input terminal 1 have the common node 108. The anode 41 of the input diode 4 has the common node 109 together with the inductance terminal 81 of the input inductance 8 and the electrode 61 of the input capacitance 6.

The means 11 for forwarding the electrical output power to the output terminal 3 has, as in example 1, the common node 104 of the counterelectrode 72 of the transfer capacitance 7 and the further inductance terminal 92 of the base point inductance 9. In contrast to example 1, said node 104 and the cathode 52 of the output diode 5 are electrically conductively connected to one another. The anode 52 of the output diode 5 and the output terminal 3 are electrically conductively connected to one another and have the common node 110.

### EXAMPLE 4

The circuit diagram of the associated electrical circuit IV is illustrated in FIG. 4. In contrast to example 2, a negative DC voltage is applied via the input terminal 1. This results in the following differences in the arrangement of the elements in comparison with example 2:
The further inductance terminal 162 and the cathode 52 of the output diode 5 are electrically conductively connected to one another and have the common node 111.
The electrode 171 of the output capacitance 17 and the common node 111 of the further inductance terminal 162 of the secondary inductance 16 and the cathode 52 of the output diode 5 are electrically conductively connected to one another.

The electrical circuits I to IV described are used for power factor correction, the electrical input power fed in being subjected to power factor correction. This means that the phases of current and voltage are brought in phase. The maximum amplitudes of current and voltage attain temporal coincidence. The input power fed in by means of the pulsating DC voltage (frequency of 100 Hz) is converted into an output power with an efficiency of 80% to 95%. The output power is drawn with a DC voltage pulsating with the switching frequency of the radiofrequency switch.

### LIST OF REFERENCE SYMBOLS

I-IV electrical circuits
1 Input terminal
2 Reference potential terminal
3 Output terminal
4 Input diode
5 Output diode
6 Input capacitance
7 Transfer capacitance
8 Input inductance
9 Base point inductance
10 Radiofrequency switch
11 Means for forwarding the electrical output power to the output terminal
12 Tuning capacitance
13 Further reference potential terminal
14 Transformer
15 Primary inductance of the transformer
16 Secondary inductance of the transformer
17 Output capacitance
41 Anode of the input diode
42 Cathode of the input diode
51 Anode of the output diode
52 Cathode of the output diode
61 Electrode of the input capacitance
62 Counterelectrode of the input capacitance
71 Electrode of the transfer capacitance
72 Counterelectrode of the transfer capacitance
81 Inductance terminal of the input inductance
82 Further inductance terminal of the input
inductance
91 Inductance terminal of the base point inductance
92 Further inductance terminal of the base point inductance
100 Common node of the input terminal and the anode of the input diode
101 Common node of the cathode of the input diode, the inductance terminal of the input inductance and the electrode of the input capacitance
102 Common node of the counterelectrode of the input capacitance, the inductance terminal of the base point inductance and the reference potential terminal
103 Common node of the further inductance terminal of the input inductance and the electrode of the transfer capacitance
104 Common node of the counterelectrode of the transfer capacitance and the further inductance terminal of the base point inductance
105 Common node of the output terminal and the cathode of the output diode
106 Common node of the further reference potential terminal and the inductance terminal of the secondary inductance
107 Common node of the further inductance terminal of the secondary inductance and the anode of the output diode
108 Common node of the input terminal and the cathode of the input diode
109 Common node of the anode of the input diode, the inductance terminal of the input inductance and the electrode of the input capacitance
110 Common node of the output terminal and the anode of the output diode
111 Common node of the further inductance terminal of the secondary inductance and the anode of the output diode
121 Electrode of the tuning capacitance
122 Counterelectrode of the tuning capacitance
151 Inductance terminal of the primary inductance of the transformer
152 Further inductance terminal of the primary inductance of the transformer
161 Inductance terminal of the secondary inductance of the transformer
162 Further inductance terminal of the secondary inductance of the transformer
171 Electrode of the output capacitance
172 Counterelectrode of the transfer capacitance

1. An electrical circuit (I, II) for voltage transformation, having
at least one input terminal (1) for feeding in an electrical input power by applying a positive electrical DC voltage that changes temporally with respect to an electrical reference potential,
at least one reference potential terminal (2) for applying the reference potential,
at least one output terminal (3) for drawing an electrical output power,
at least one input diode (4) having an anode (41) and a cathode (42),
at least one output diode (5) having an anode (51) and a cathode (52),
at least one input capacitance (6) having an electrode (61) and a counterelectrode (62),
at least one transfer capacitance (7) having an electrode (71) and a counterelectrode (72),
at least one input inductance (8) having an inductance terminal (81) and a further inductance terminal (82), and
at least one base point inductance (9) having an inductance terminal (91) and a further inductance terminal (92),
in which case
the anode (41) of the input diode (4) and the input terminal (1) have a common node (100),
the cathode (42) of the input diode (4), the inductance terminal (81) of the input inductance (8) and the electrode (61) of the input capacitance (6) have a common node (101),
the counterelectrode (62) of the input capacitance (6), the reference potential terminal (2) and the
inductance terminal (91) of the base point inductance (9) have a common node (102),
the further inductance terminal (82) of the input inductance (8) and the electrode (71) of the transfer capacitance (7) have a common node (103),
the counterelectrode (72) of the transfer capacitance (7) and the further inductance terminal (92) of the base point inductance (9) have a common node (104), a radiofrequency switch (10) for producing and/or interrupting an electrically conductive connection between the reference potential terminal (2) and the common node (103) of the further inductance terminal (82) of the input inductance (8) and the electrode (71) of the transfer capacitance (7) and
a means (11) for forwarding the electrical output power to the output terminal (3) are present, the means (11) having the base point inductance (9) and the output diode (5) and the cathode (52) of the output diode (5) having a common node (105) with the output terminal (3).

2. The circuit as claimed in claim 1, the means (11) for forwarding the electrical output power to the output terminal (3) having
the common node (104) of the counterelectrode (72) of the transfer capacitance (7) and the further inductance terminal (92) of the base point inductance (9), and
said node (104) and the anode (51) of the output diode (5) being electrically conductively connected.

3. The circuit as claimed in claim 1, the means (11) for forwarding the electrical output power comprising
at least one further reference potential terminal (13) for applying a further reference potential and
at least one transformer (14), having
at least one primary inductance (15) having an inductance terminal (151) and a further inductance terminal (152) and
at least one secondary inductance (16) having an inductance terminal (161) and a further inductance terminal (162),
in which case
the primary inductance (15) has the base point inductance (9),
the inductance terminal (161) of the secondary inductance (16) and the further reference potential terminal (13) have a common node (106) and
the further inductance terminal (162) and the anode (51) of the output diode (5) have a common node (107).

4. The circuit as claimed in claim 3, the means (11) for forwarding the electrical output power having
at least one output capacitance (17) having an electrode (171) and a counterelectrode (172),
the counterelectrode (172) of the output capacitance (17) and the common node (106) of the further reference potential terminal (13) and the inductance terminal (161) of the secondary inductance (16) being electrically conductively connected and
the electrode (171) of the output capacitance (17) and the common node (107) of the further inductance terminal (162) of the secondary inductance (16) and the anode (51) of the output diode (5) being electrically conductively connected.

5. An electrical circuit (III, IV) for voltage transformation, having
at least one input terminal (1) for feeding in an electrical input power by applying a negative electrical DC voltage that changes temporally with respect to an electrical reference potential,
at least one reference potential terminal (2) for applying the reference potential,
at least one output terminal (3) for drawing an electrical output power,
at least one input diode (4) having an anode (41) and a cathode (42),
at least one output diode (5) having an anode (51) and a cathode (52),
at least one input capacitance (6) having an electrode (61) and a counterelectrode (62),
at least one transfer capacitance (7) having an electrode (71) and a counterelectrode (72),
at least one input inductance (8) having an inductance terminal (81) and a further inductance terminal (82), and
at least one base point inductance (9) having an inductance terminal (91) and a further inductance terminal (92),
in which case
the cathode (42) of the input diode (4) and the input terminal (1) have a common node (108),
the anode (41) of the input diode (4), the inductance terminal (81) of the input inductance (8) and the electrode (61) of the input capacitance (6) have a common node (109),
the counterelectrode (62) of the input capacitance (6), the reference potential terminal (2) and the
inductance terminal (91) of the base point inductance (9) have a common node (102),
the further inductance terminal (82) of the input inductance (8) and the electrode (71) of the transfer capacitance (7) have a common node (103),
the counterelectrode (72) of the transfer capacitance (7) and the further inductance terminal (92) of the base point inductance (9) have a common node (104),
a radiofrequency switch (10) for producing and/or interrupting an electrically conductive connection between the reference potential terminal (2) and the common node (103) of the further inductance terminal (82) of the input inductance (8) and the electrode (71) of the transfer capacitance (7) and
a means (11) for forwarding the electrical output power to the output terminal (3) are present, the means (11) having the base point inductance (9) and the output diode (5) and the anode (51) of the output diode (5) having a common node (110) with the output terminal (3).

6. The circuit as claimed in claim 5, the means (11) for forwarding the electrical output power to the output terminal (3) having
the common node (104) of the counterelectrode (72) of the transfer capacitance (7) and the further inductance terminal (92) of the base point inductance (9), and
said node (104) and the cathode (52) of the output diode (5) being electrically conductively connected.

7. The circuit as claimed in claim 5, the means (11) for forwarding the electrical output power comprising
at least one further reference potential terminal (13) for applying a further reference potential and
at least one transformer (14), having
at least one primary inductance (15) having an inductance terminal (151) and a further inductance terminal (152) and
at least one secondary inductance (16) having an inductance terminal (161) and a further inductance terminal (162),
in which case
the primary inductance (15) has the base point inductance (9),
the inductance terminal (161) of the secondary inductance (16) and the further reference potential terminal (13) have a common node (106) and
the further inductance terminal (162) and the cathode (52) of the output diode (5) have a common node (111).

8. The circuit as claimed in claim 7, the means (11) for forwarding the electrical output power having
at least one output capacitance (17) having an electrode (171) and a counterelectrode (172),
the counterelectrode (172) of the output capacitance (17) and the common node (106) of the further reference potential terminal (13) and the inductance terminal (161) of the secondary inductance (16) being electrically conductively connected and
the electrode (171) of the output capacitance (17) and the common node (111) of the further inductance terminal (162) of the secondary inductance (16) and the cathode (52) of the output diode (5) being electrically conductively connected.

9. The circuit as claimed in claim 3, the transformer (15) being a radiofrequency/high-voltage transformer.

10. The circuit as claimed in claim 1, in which case
for the purpose of relieving the switching load on the radiofrequency switch (10), at least one tuning capacitance (12) having an electrode (121) and a counterelectrode (122) is present,
the electrode (121) of the tuning capacitance (12) and the common node (103) of the further inductance terminal (82) of the input inductance (8) and the electrode (71) of the transfer capacitance (7) are electrically conductively connected and
the counterelectrode (122) of the tuning capacitance (12) and the reference potential terminal (2) are electrically conductively connected.

11. The circuit as claimed in claim 1, the radiofrequency switch having at least one MOS transistor.

12. The circuit as claimed in claim 1, the radiofrequency switch (10) having a switching frequency selected from the range of 500 kHz to 200 MHz inclusive.

13. The circuit as claimed in claim 1, the input capacitance (6) and/or the transfer capacitance (7) having at least one radiofrequency capacitor having a capacitance selected from the range of 10 pF to 1000 pF inclusive.

14. The circuit as claimed in claim 10, the tuning capacitance (12) having at least one radiofrequency capacitor having a capacitance selected from the range of 10 pF to 200 pF inclusive.

15. The circuit as claimed in 4, the output capacitance (17) having at least one radiofrequency capacitor having a capacitance selected from the range of 300 pF to 3000 pF inclusive.

16. The circuit as claimed in claim 1, the input inductance (8), the base point inductance (9), the primary inductance (15) and/or the secondary inductance (16) having an inductance selected from the range of 0.3 μH to 100 μH inclusive.

17. The circuit as claimed in claim 1, the input diode (4) and/or the output diode (5) being a Schottky diode having at least one diode material selected from the group SiC and/or GaAs.

18. The use of the circuit as claimed in claim 1 for power factor correction, a power drawn from a power supply system being corrected in terms of the power factor.
